(19) United States
(12) Patent Application Publication
(10) Pub. No.: US 2024/0290507 A1
(43) Pub. Date: Aug. 29, 2024

(54) Particle Generating Apparatus

(71) Applicant: Astral Neutronics Ltd, London Greater London (GB)

(72) Inventors: Tom Wallace-Smith, London (GB); Talmon Firestone, London (GB)

(21) Appl. No.: 18/571,220

(22) PCT Filed: Jun. 15, 2022
(86) PCT No.: PCT/GB2022/051516

§ 371 Date: Dec. 16, 2023

(30) Foreign Application Priority Data
Jun. 18, 2021 (GB) 2108736.6

(51) Int. Cl. G21B 1/19; G21B 1/03; G21B 1/05

(52) U.S. Cl. CPC G21B 1/19; G21B 1/03; G21B 1/05

(57) ABSTRACT

Particle production apparatuses and systems comprising the same are provided. A particle producing apparatus of the inertial electrostatic confinement type comprises a vessel, an anode structure and a cathode structure, wherein the anode structure and cathode structure are positioned within the vessel. The particle production apparatus further comprises a first enriched surface that is enriched with fusible isotope species, wherein the first enriched surface is at least a part of a surface of the anode structure or a surface of the cathode structure.

### FIELD OF INVENTION

The disclosure relates to a particle producing apparatus of the inertial electrostatic confinement type, in particular a particle producing apparatus having an anode structure, a cathode structure and a first enriched surface, the first enriched surface being enriched with fusible isotope species wherein the first enriched surface is at least a part of a surface of the anode structure or a surface of the cathode structure.

### BACKGROUND

In man-made fusion, forces are utilised to impart adequate kinetic energy to fusible isotope species (FIS). FIS consists of the isotopes of Hydrogen (Hydrogen, Deuterium and Tritium) as well as Helium-3 for the purposes of neutron and proton generation respectively. Alternative FIS are possible such as Boron and Lithium in conjunction with the aforementioned isotopes. Forces take the form of magnetic plasma confinement, particle beam accelerators, pulsed laser heating and any combination of electromagnetic confinement fields are used to focus ions into a collision zone. The first ever fusion-based technology successfully commercialised was an Inertial-Electrostatic Confinement (IEC) neutron generator. In an IEC, the reactor vessel contains a meshed cathode in the centre and its inner wall acts as an anode. The chamber is filled with FIS gas and a high voltage is applied to the cathode, creating a strong electric field within the chamber which accelerates the ions, sparking a plasma at the centre of the cathode where fusion occurs. IEC neutron generators have demonstrated reliable capability to produce neutron fluxes up to 5×10⁹ neutrons per second for Deuterium-Tritium fusion for tens of thousands of hours continuously with little to no maintenance.

Several means of producing ions and mitigating collisions that only cause losses are known. Methods that produce low energy ions include electron emitter or dispenser cathodes that provide electrons that are able to oscillate about one or two external grids. The ionization in the external region near to the anode wall may contribute the ions to the “zone of acceptance” for channeling into the spokes or beams. There is some question about the losses such as defocusing that may be introduced. However, the complexity and consequential cost of manufacture are too high for the gain in performance. The reliability, and longevity of additional insulator stand-offs, delicate large grids, additional vacuum electrical feed through penetrations in a sealed system plus the short operational life of electron emitters and the deleterious effect of an aggressive hydrogen gas-plasma atmosphere on the dispenser cathode are all drivers towards a more cost-effective technology. In addition, electron emitters demand significant power in the atmosphere of the operating IEC environment.

Existing IEC arrangements use Aluminium or stainless steel as a material for the anode and Molybdenum or Tungsten for the cathode for secondary electron emission properties, thermal resistance, low cost and ease of manufacture. However, for applications requiring high particle production rates more suitable materials can be used to improve these properties and hence increase the particle production rate. In particular, there is a need for materials which can accommodate light ions to high concentrations and exhibit substantial secondary electron emission.

Many different multi-particle interactions can be used to generate nucleons. Some examples of such fusion reactions and the generated particle kinetic energies are:

$$\begin{matrix}1. & \\ {D}_{1}^{2} + {D}_{1}^{2} \to {He}_{2}^{3} ( 0.82 MeV ) + {n}_{0}^{1} ( 2.45 MeV ) & \end{matrix}$$

$$\begin{matrix}2. & \\ {D}_{1}^{2} + {D}_{1}^{2} \to {T}_{1}^{3} ( 1.01 MeV ) + {p}_{1}^{1} ( 3.02 MeV ) & \end{matrix}$$

$$\begin{matrix}3. & \\ {D}_{1}^{2} + {T}_{1}^{3} \to {He}_{2}^{4} ( 3.5 MeV ) + {n}_{0}^{1} ( 14.1 MeV ) & \end{matrix}$$

$$\begin{matrix}4. & \\ {D}_{1}^{2} + H {e}_{2}^{3} \to {He}_{2}^{4} ( 3.6 MeV ) + {p}_{1}^{1} ( 14.7 MeV ) & \end{matrix}$$

wherein D₁² is deuterium, T₁³ is tritium, He₂³ is helium, n₀¹ is a neutron and p₁¹ is a proton.

The reactions in equations 1-4 above demonstrate the variety of available particles and energies depending on the mix of FIS. Where fusion can be produced in a controlled environment, such as a particle generator or fusion reactor, reactions of higher energy and lower mass can be collimated and attenuated to be made use of in many different ways. In particular, the neutrons and protons of higher energy in equations 3 and 4 are unique in that they are otherwise difficult or impossible to produce by means other than fusion. The particles in equations 1 and 2 can be generated through fission reactions where 2.45 MeV neutrons are plentiful or through particle accelerators where a proton can be accelerated by electromagnetic fields to 3.02 MeV.

Whilst neutrons are eminently useful, there are difficulties around their cheap, reliable, safe and on-demand production. Historically, Californium-252 neutron sources have been the standard, but the constant uncontrollable emission of neutrons imposes complex operational safety requirements. Additionally, the half-life of the material being 2.5 years implies a short lifetime of the source as well as inherent disposal complications and costs.

An alternative technology that is currently available is an advanced tube neutron generator, or compact linear accelerator. Typically, this takes the form of a Deuterium ion source which is linearly accelerated into a concentrated beam by an electric field into a solid or gaseous Tritium target to induce fusion reactions and neutron production. Such systems have been commercialised, but their use is limited due to large upfront and running costs. This is mainly due to the infrastructure needed to run the accelerator, unintentional activation of materials from stray energetic deuterium fluence as well as erosion or burnup of the Tritium target requiring regular replacement. This also implies the system is not continuously operable for long periods.

### DESCRIPTION OF PRIOR ART

Particle generator devices are discussed in WO03019996. The generators in WO03019996 are described with focus on the differences from a linear geometry long-life plasma-gas target line source topology particle generating device.

WO03019996 discloses a cylindrical IEC device of low neutron production rate and high reliability and simplicity. This document also suggests the use of Aluminium for the anode wall because it emits electrons when exposed to intense ultraviolet radiation which encourages the ionization processes discussed above.

### SUMMARY OF THE INVENTION

In accordance with some implementations of the present disclosure, there is provided a particle producing apparatus of the inertial electrostatic confinement type, comprising: a vessel; an anode structure; a cathode structure, wherein the anode structure and cathode structure are positioned within the vessel; and a first enriched surface, the first enriched surface being enriched with fusible isotope species. The first enriched surface is at least a part of a surface of the anode structure or a surface of the cathode structure. The enriched surface may prompt lattice confinement fusion. This apparatus may be configured to contain an ion and neutral gas mixture and, in operation, to cause the ion and neutral gas mixture to form a plasma.

The vessel of said apparatus may comprise a central axis. The anode and cathode structure may be positioned such that the anode structure and cathode structure are substantially coaxial with the vessel, the anode structure having a mean distance from the central axis that is larger than the mean radius from the central axis of the cathode structure. The anode and cathode structures may be substantially concentric along at least a part of their lengths and configured such that, in operation, an electric field is provided between the anode and cathode structures and the first enriched surface is electron screened. This electron screening may encourage lattice confinement fusion. The vessel may also have a substantially constant cross-section coaxially along the length of the cathode structure. The anode may be formed of a plurality of anode units.

The first enriched surface may be formed of a basic or transition metal. This metal may be an element with an atomic number greater than 40, and more specifically may be one of Titanium, Zirconium, Palladium, or Erbium. Preferably, the metal may be Zirconium. Alternatively, the first enriched surface may be formed of a semiconductor material. This semiconductor material may be CVD diamond.

The first enriched surface may be provided as a coating on the anode structure or cathode structure. Alternatively, the first enriched surface may be formed integrally with the electrode that it forms at least part of the surface of.

The apparatus may be configured such that, in operation, the apparatus produces nucleons. These nucleons may be neutrons or protons.

For an apparatus configured such that, in operation, the apparatus produces protons, the apparatus may further comprise fluid conducting structures proximate to the anode structure. These fluid conducting structures may be composed of a metal alloy. Additionally, these fluid conducting structures may comprise corrugations along a length of the fluid conducting structures.

The first enriched surface may be configured to cover a portion of the surface area of the anode structure or cathode structure such that in operation the produced particles have a localised flux with a predetermined geometry.

In some embodiments, the first enriched surface may form at least a part of the surface of the anode structure, and a second enriched surface may form at least a part of the surface of the cathode structure, the second enriched surface being enriched with fusible isotope species.

In accordance the present disclosure, there is provided a system comprising a plurality of particle producing apparatuses, wherein each particle producing apparatus is a particle producing apparatus as described above, configured such that a single power supply can serve several systems.

### BRIEF DESCRIPTION OF DRAWINGS

For a better understanding of the present disclosure and to show how it may be carried into effect, reference shall now be made by way of example to the accompanying drawings, in which:

FIG. 1 illustrates an inertial electrostatic-lattice confinement (IELC) device cut-through in accordance with some embodiments.

FIG. 2 illustrates a cross sectional representation of the geometrical layout of an anode and a cathode for a proton generator configuration of the IELC in accordance with some embodiments.

FIG. 3 illustrates a cross sectional representation of a further proton generator IELC for the generation of PET radioisotopes in accordance with some embodiments.

FIG. 4 illustrates a proton generator system function schematic for medical isotope production configuration in accordance with some embodiments.

FIG. 5 illustrates multiple unit configurations arranged in parallel, including localised anode enrichment, in accordance with some embodiments.

FIG. 6 illustrates further multiple unit configurations arranged in series, including localised anode enrichment in accordance with some embodiments.

### DETAILED DESCRIPTION

The theorisation and measurement of Lattice Confinement Fusion (LCF) has demonstrated fusion reactions taking place in a solid metal under electron screened conditions. Here, the negatively charged electron cloud present in conductive metals neutralises the positive charge of fusible ions located in the metal lattice. Incident accelerated ions are not repulsed by the electrostatic force usually seen between two positively charged particles, allowing for the fusion reactions seen below to take place with less required energy and at enhanced rates. “Strong Screening by Lattice Confinement and Resultant Fusion Reaction Rates” by Prados-Estévez, F., Subashiev, A. and Nee, H. discussed how the top 10 valence electrons in a given metal can nullify the coulomb potential between fusible isotope species thereby increasing the fusion reaction cross section and allowing for fusion at high rates in solid metals. A saturation effect is also anticipated and seen to occur.

LCF effects change little between FIS or their associated reactions but vary for different host metals due to their innate screening potential. For an IELC system, stability of the infused Hydrogen species at high temperatures and in the presence of radiation is paramount. This limits the suitable candidate materials to those like Palladium, Erbium and Zirconium among others. Extensive work into the Hydride properties of Zr has been performed in relation to its use as a fuel cladding alloy in fission reactors, which has highlighted its stability at high temperatures and in the presence of high doses of radiation.

Electrolysis represents quick and efficient way to load any mixture of Deuterium or Tritium into the Zirconium lattice at atomic percentage levels without the use of an ion beam or complex metallurgy. This represents an available manufacture route for a FIS enriched cathode or FIS enriched anode as described in the present disclosure.

In addition, the electron emission of the cathode grid can significantly influence the fusion rate. The use of identical geometry grids made of different metal gives a significant difference of fusion rate with all other parameters the same. An advantageous material candidate for the anode or cathode is single crystal or polycrystalline CVD diamond which exhibits excellent performance at high power inputs, high thermal conductivity, high thermal and radiation hardness as well as exhibiting strong thermionic electron emission properties. Additionally, it is possible to grow CVD diamond on Tungsten for example, using a Deuterium and/or Tritium plasma mixture which enriches the material to atomic percentage concentrations of FIS.

In embodiments of the present disclosure, the potential is positive at the anode and negative at the cathode so once neutral gases are ionized, they become positive ions which are repulsed from the anode surface and attracted to the cathode surface, and are therefore accelerated towards the plasma. Through a combination of thermionic and photo-electric effects, electron emission may occur at the cathode surface. The electrons emitted from the cathode are repulsed from the cathode and accelerated towards the anode due to their negative charge. These high energy electrons cause secondary electrons to ionize the neutral gas at the anode wall, which then accelerates towards the cathode due to its positive charge and contribute to the plasma.

Ions born at the anode surface may contribute more to fusion due to being accelerated a larger distance by the electric field into the potential well inside the cathode. Through the use of materials enriched with FIS for the anode or cathode, not only may there be increase in lattice confinement fusion in the materials compared to conventional IEC's but at adequate temperature the FIS may diffuse into the reactor chamber, become ionised and contribute significantly to the particle production rate of the system. Careful control of the temperature of the anode through precise cooling may allow for a controlled release of FIS into the chamber to maintain an increased particle production rate. This can be managed by an automated system which manages the power, particle production rate and temperature to provide a stable output.

As is well established, all systems may saturate at a stable state where particle production is constant. In the present disclosure, saturation occurs but for an additional reason where at a given temperature there is an equilibrium between the steady release of ions due to degradation of the hydride surface layer and assimilation of Hydrogen isotopes into the lattice bulk. This process can be beneficial or detrimental to the particle production rate dependent on the material used for the anode and cathode. Regardless, careful control of the cathode and anode temperatures are key to maximising the particle production rate of the system. For very high particle production rates approaching the neutron flux densities of 1 MW fission reactors it may be advantageous to use cryogenic systems.

A particular advantage of embodiments of the present disclosure is that neutron output can be made extremely consistent as it reaches a steady state when run at a fixed power input as discussed above, which means that it is relatively easy to remove extraneous noise effects in practical applications of the disclosure by an appropriate noise subtraction process. Thus, embodiments of the present disclosure may provide apparatus for producing nuclear fusion reaction rates with high stability as defined by a measurable neutron flux at conditions of specified voltage, current and temperature.

According to the present disclosure, materials which can contain high levels of fusible ion species such as Zr or CVD diamond encourage LCF as well as secondary electron emission. This is especially true for CVD diamond, a semiconductor with an indirect bandgap in the region of UV but with far superior thermal properties and relatively easy techniques for application to complex geometric surfaces used in tool manufacture. Therefore, it is possible to pair the particle production techniques of increased secondary electron emission and lattice confinement fusion by enhancement of the anode and cathode material surfaces. An axial cylindrical IELC system may also have enhanced fusion rates. Such means may be incorporated into embodiments of the present disclosure.

The electrodes may be made of these materials or instead may have coatings of appropriate materials. Such materials include CVD diamond, Molybdenum, Tungsten, Zirconium and other basic or transition metal elements, potentially rare earth elements.

Hence, embodiments of the present disclosure may provide apparatus for producing nuclear fusion reactions by utilization of characteristics of an inertial electrostatic-lattice confinement (IELC) device with ions initially produced by glow-discharge breakdown of a reactant gas plus ion-impact and electron-impact processes in a plasma gas mix and also a favourable production of secondary electrons of low energy which are well suited for further ion production after impact of high energy electrons and ions on structures located at or near an anode wall as well as production of FIS from the anode wall. Two complimentary phenomena act to increase the particle production rate:
1. Generation of secondary electrons from the Cathode surface, increased by choice of material. These electrons gain significant energy from the electric field and are accelerated into the anode wall. The Cathode material can also be enriched with fusible species to encourage lattice confinement fusion events and increase plasma density.
2. Enrichment of the inner surface of the anode with fusible species within an appropriate metal such as Titanium, Zirconium, Palladium, Erbium or semiconductor material e.g., CVD diamond, where the material is electron screened, inducing lattice confined fusion events and producing secondary electrons which allow for anode-born ions to ionise and contribute to the particle production rate within the central cathode region.

The operating temperatures of the anode and cathode typically relate to their capability to increase the particle production rate.

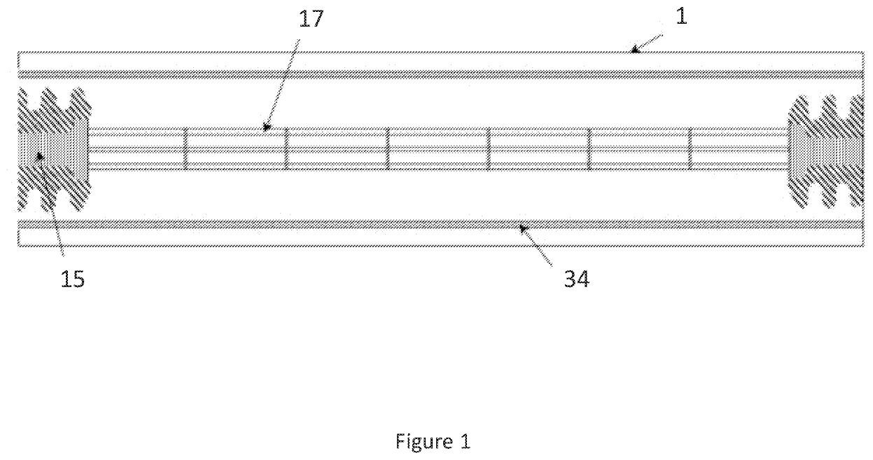

FIG. 1 shows a view of a cut through model of a neutron generating configuration for an IELC particle generating device. FIG. 1 shows the following components: 1 Outer chamber wall, 15 high voltage stand-off component, 17 cathode assembly, and 34 localised fusible isotope species enriched inner anode surface.

Specifically, FIG. 1 demonstrates an IELC cut-through showing the flanged cylindrical cathode, encompassing anode surface and appended ceramic insulators at either end including voltage feedthroughs. The IELC device referred to in the present disclosure may include fusible ion species enriched anode 34 and or cathode 17 materials. These materials may be chosen for secondary electron emission properties as well as the ability to retain high levels of fusible ion species to high temperatures whilst remaining stable, including and not limited to Zirconium, Titanium, Aluminium, other rare earth metals, high entropy alloys and their associated oxides and hydrides. FIG. 1 represents the simplified neutron generator configuration where the deuterium or tritium gas species are released and stored in a getter material within the sealed vessel.

Embodiments of the present disclosure may provide apparatus for producing nuclear fusion reactions by utilization of characteristics of a so-called star mode of operation. Star mode of operation refers to a mode of operation in which a plasma is produced inside the apparatus. As a result, embodiments are envisaged wherein the apparatus is configured to contain an ion and neutral gas mixture and, in operation, to cause the ion and neutral gas mixture to form a plasma. Additionally, embodiments of the present disclosure may provide apparatus for producing nuclear fusion reactions by utilization of an ion capture phenomenon called “zone of acceptance”, whereby a spatial region centred on each star beam and having a curved funnel-like shape with its broadest end at an anode wall defines a region where ions born with relatively low kinetic energy may be drawn into a local star beam from the gas plasma, anode and/or cathode surfaces.

A cathode grid 17 shape may be adapted so that formation and shape characteristics of star mode beams and a zone of acceptance are controlled to maximize or at least improve the above-described production and utilization of ions for fusion collisions. The grid 17 may be constructed out of panels and may be shaped such that the panels run lengthways to form a hollow cylinder or cylindrical skeletal frame. The cathode grid 17 may comprise flanges, and the flanges may be made from said panels. These flanges may distribute the electric field between the cathode grid and the anode such that the field is concentrated near the flanges to produce beams or channels. For example, these channels may form in between neighbouring, adjacent or proximate flanges. These beams or channels may result in improved acceleration of generated ions towards the plasma, which may be located in the centre of the electric field and/or where the beams or channels intersect. These electric field channels may be considered to be the zone of acceptance. Thus, embodiments of the present disclosure are provided wherein produced nucleons can escape from a sealed apparatus in all directions from a zone of origin that is elongated and able to replace a line source made of many discrete pellets of radioactive neutron emitting isotope such as Californium-252 or discrete point sources like point source neutron generator apparatus.

Thus, embodiments of the present disclosure may provide apparatus for producing nuclear fusion reactions in a volume or zone as defined above which extends from a centreline to an anode and includes an internal cathode and a space external to it for a radial distance of approximately one half of a radius of the cathode 17, as well as to the inner surface wall of the anode 34 where it has been suitably enriched with fusible isotope species. In addition, embodiments of the present disclosure may provide apparatus for producing nuclear fusion reactions in an elongated zone or multiple zone segments in the case of a curvilinear geometry within a reactor vessel. In other words, embodiments of the present disclosure may provide apparatus for producing nuclear fusion reactions in a volume centred on a centreline axis or line of cylindrical symmetry of a reactor vessel.

Unlike in a typical linear accelerator, nucleons produced by embodiments of the present disclosure may be multi-directional. Embodiments of the present disclosure seek to replace a multi-millimetre diameter intense mono directional beam of accelerated energetic protons made by a particle accelerator apparatus which impinge on a target causing relatively rapid damage. In comparison to a linear accelerator, the present disclosure may spread out proton production over larger precursor material volume which can be readily processed to easily extract pure isotope for use. Hence, embodiments of the present disclosure may provide apparatus for producing nuclear fusion reactions for a duration of thousands of hours to several years with little or no maintenance to a reactor chamber containing a FIS enriched anode and/or cathode. Similarly, embodiments of the present disclosure may provide apparatus for producing nuclear fusion reactions with: little or no maintenance to a central electrode 17 or an associated high voltage power input structure, little or no maintenance to an internally mounted reactor chamber gas storage and pressure regulation device, and/or little or no maintenance to an internally mounted conduit structure for aqueous fluids between the substantial vacuum vessel wall 1 and the inner facing wall which of generally thin foil thickness. The materials chosen for the cathode and anode may be selected to encourage secondary electron emission, resistance to thermal damage and lattice confinement fusion.

Furthermore, as described above the apparatus may be adapted such that ions born or generated within a zone of acceptance between the anode wall and the perimeter of the cathode grid 17 may be drawn into the star mode beam around which the zone of acceptance may be substantially centred and which has cathode hole window side segment curvatures which may be suited to a shape of planes of equipotential in the electrostatic field to increase a size of the zone of acceptance and thereby capture most or substantially all ions produced by interactions of neutrals with secondary electrons near the anode wall 34.

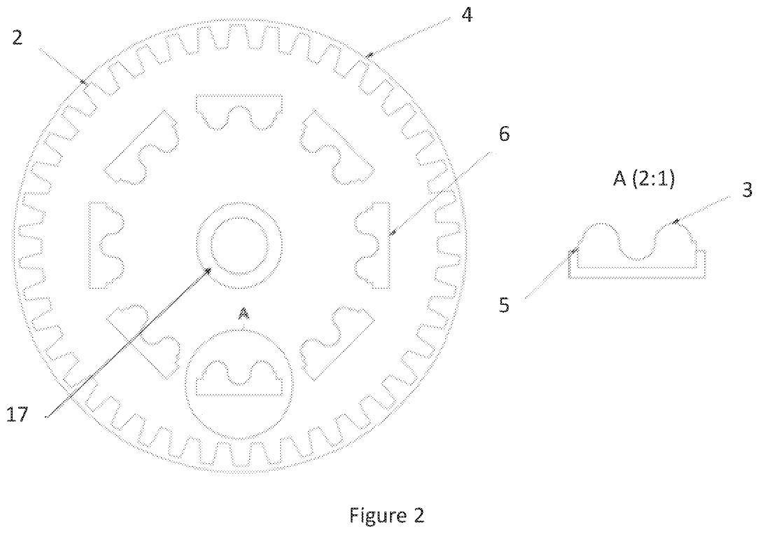

FIG. 2 illustrates an integrated vessel. Specifically, FIG. 2 shows a cross sectional representation of the geometrical layout of the anode and cathode for the proton generator configuration of the IELC. FIG. 2 shows the following components: 2 corrugated chamber wall, 3 corrugated thin FIS enriched anode surface, 4 outer chamber surface, 5 anode wall component, 6 anode supporting structure and 17 cathode assembly. The wall and heat transfer component 1 may provide the advantage of reduced manufacturing cost. Thus, embodiments of the present disclosure may provide apparatus for producing increased nuclear fusion reaction rates with several reactant gas ionization enhancements which are compatible with a low-maintenance and low-cost system. The component may be produced as an extrusion of aluminium alloy by well-known means, such as aluminium extruded through a suitable hole. The combined function fluid or gas conduit and anode wall may be fabricated from stainless steel or material of similar properties to achieve manufacturability and function. An advantageous vessel topology is an eight-sided polygonal form, in other words with an octagonal cross-section. This topology may have improved robustness over topologies with a greater number of vertices. For example, a cross-section with a higher number of vertices may allow for higher degrees of symmetry, and hence allow for an increased number of fluid conducting structures. These fluid conducting structures may act as cooling channels for the device. However, a cross-section with a higher number of vertices may be more expensive to construct and less robust. A cross-section with a reduced number of vertices may be vulnerable to temperature variations due to a reduced number of fluid conducting structures and an increased impact of material impurities. An octagonal cross-section may be a desirable compromise between these two extremes. Thus, embodiments of the present disclosure may provide apparatus for producing nuclear fusion reactions that is structurally robust for operation in mobile vehicles. Similarly, embodiments of the present disclosure may provide apparatus for neutron or proton producing nuclear fusion reactions that is structurally robust for operation in hospital locations in static or movable systems.

The central cathode 17, anode structure 3/6 and outer chamber or vessel 4 may be coaxial. Specifically, the vessel 4 may comprise a central axis, and the anode and cathode structures may be positioned such that the anode structure 3/6 and cathode structure 17 are substantially coaxial with the vessel. The anode structure 3/6 may have a mean distance from the central axis that is larger than the mean radius from the central axis of the cathode structure 17, wherein the anode and cathode structures are substantially concentric along at least a part of their lengths and configured such that, in operation, an electric field is provided between the anode and cathode structures and the first enriched surface is electron screened. The vessel 4 may have a substantially constant cross-section coaxially along the length of the cathode structure. Thus, embodiments of the present disclosure may provide apparatus for producing nuclear fusion reactions in a curvilinear source configuration which can be conformal to curved linear forms of specified objects that are to be irradiated.

The exterior may have integrated cooling fins 2 that are sized to fit within a cylindrical housing 4. The housing 4 may serve as a cowling or duct for a coolant fluid (such as air) so that heat transfer from the fins 2 to the fluid flowing past can be facilitated. It is feasible to use a liquid coolant for transfer of greater heat flux. It is also feasible to use liquid coolant such as water circulated in a tubing system that is brazed to the vessel wall 1.

In the present embodiment, in the proton generating mode, the anode wall may be constructed so as to provide a conduit for precursor fluids. It is therefore characterized by an inner wall which serves as the electrical anode for the reactor. The sides of the conduit that are not directly exposed to the cathode may have a structural function. The inner wall may have a function that is central to the intended function of the present improvement.

The detailed insert view A (2:1) of FIG. 2 shows for illustrative purposes the cross-section of an example of an inserted fluid conduit and enriched anode wall components 5 which may locate on surface of the inside wall of the vessel 1. As discussed above there are well known phenomena that can be exploited in order to increase the production of low energy electrons. The ionization of the reactant gas species (not shown) may provide a high intensity flux of UV photons which may meet the vessel wall 1. The incidence of high energy electrons which have been accelerated by the intense electrostatic field of the present disclosure may cause the emission of secondary electrons of low energy. These low energy electrons may be well suited for ionization of Hydrogen and Helium. The population of ions near the enriched anode 1 may be greatly increased. To ensure an increase of the low angle of incidence of the high energy electrons that stream toward the anode in the local radial direction, the surface may be shaped as shown with corrugations 3. The height of the peaks may be low in order to keep them within the electrostatic field potential zone where the greatest ionization efficiency can be achieved. The width of the ridges 3 may also be low in order to fit as many as possible into the available area. The design considerations may be influenced by the cost of manufacture. If the vessel wall 1 and anode structure 6 is based on a cylindrical tube section, it is also acceptable to make the ionization enhancement ridges 3 as a screw thread or spiral tube on the inside wall surface. These may run in a circumferential direction rather than a longitudinal direction as in the case of an extruded form.

As shown in FIG. 2, the anode structure 6 may be formed of multiple anode wall components 6 and enhancement ridges 3. In other words, the anode structure 6 can be considered to be formed of a plurality of anode units and comprise one or more holes and/or windows. The holes or windows of the cathode grid in conjunction with the anode wall may serve to determine planes of equal electrostatic potential. A lens effect may be produced with the superposition of a charge space of the ions and electrons when the apparatus is operating in the star mode. An electrostatic lens shape can be altered by changing the anode and the cathode geometries, for example by incorporating:
a) Substantially concentric circles for the cathode and anode.
b) A regular even number of sides of polygonal form for the anode inside wall and a corresponding number of windows on the cathode with the circumference of the window sides being generally:
   1. convex
   2. flat
   3. concave
   4. compound combinations of the above three
and each with radii of curvature and lengths of circular arc segments defined for repeated usage throughout a stack of cathode grid cells so that the star beams that are formed may be optimized or suited for secondary electron production at the anode and mitigation of ion collision with the cathode grid electrode.

Techniques such as 3D printing of the cathode can improve transparency and encourage electric field channeling ions and electrons to impact anode surfaces. Also, desirable metallurgic characteristics to handle high temperatures and high secondary electron yield also imply treatment with CVD diamond on the surfaces of the anode and cathode are advantageous in conjunction with fusible ion species enrichment.

In addition, the anode wall may be treated by passive means to promote production of multiple emissions of relatively low energy electrons that may most easily ionize reactant gas species isotopes when a surface of the anode wall is hit by a relatively high energy electron that has been accelerated by an applied electrostatic field that is present during star mode glow discharge ionization operation. Such passive means may include coating a substrate metal with rare earth elements or CVD diamond with beneficial properties and/or by imposing a surface finish that has a texture or micro geometry to promote generation of secondary electrons. In order to achieve this, the anode and/or cathode may also act as an electrode during enrichment with fusible isotope species through electrolysis by filling the chamber with sufficiently heavy water (Deuterated and/or Tritiated), inserting an electrode and applying a sufficient current density to the inner surface to promote hydrolysis. This forms the enriched layer of hydride on the inner anode wall. This can then be subsequently treated by CVD plasma using a Deuterium and/or Tritium gas mixture to grow several microns of diamond on the material surface.

Alternatively to the above method, manufacture of the FIS enriched anode and/or cathode materials can be performed by hydrolysis in which the reactor vessel may be filled with a Deuterated or Tritiated heavy water solution containing conductive salts for electrolysis. Another cathode made of a material such as Platinum in a gauze mesh can be inserted into the vessel so that the internal electric field when voltage is applied is equally distributed allowing for an even formation of hydride. Prior to hydrolysis chemical etching to remove the surface oxide can be performed. This process can be done with several reactor units in parallel using the same power supply which may require capability of several kW where liquid cooling may be beneficial for the reactor vessels in order to limit the adverse effects of heating on the conductance of the electrolysis solution. Transition metal hydrides are also possible for cathode materials in which case the same process is undertaken in an appropriate reaction vessel with a surrounding platinum gauze for the same purpose. It is also foreseeable that embodiments of the present disclosure may require wire meshes to maximize the LCF effect through increased surface area, in which case the wire can undergo electrolysis in a continuous manner whilst being threaded through a U-shaped platinum gauze mesh at the appropriate speed and applied voltage. By controlling the speed of threading and applied voltage the hydride layer can be made uniform throughout its length.

A failure mode of any metal coating of insulating surfaces may be mitigated by providing for a generally radial trajectory of both ionized and neutral particles of gas atoms, molecules and metallic particles so that migration of metal atoms towards either end of the electrode stack where non-electrically conductive electrode support structures are located, such that the failure mode may be prevented or at least reduced.

The corrugated enriched anode wall may have the secondary effect of increasing the surface area of the enriched anode, which may allow for a higher loading of fusible ion species into the device. This may have the added effect of increasing the number of anode-born ions and therefore further increasing the particle production rate. The current disclosure is not limited to the structure shown as alternative designs which may yield a higher surface area are possible, there may be a trade off with added complexity and cost with added surface area.

The corrugated enriched anode wall 3 may have a thickness determined by the energy loss of the energetic protons which is permissible to ensure that the residual energy is optimal for interaction of the protons with the designated target nuclei which are incorporated in the molecules of the fluid or the solute molecules contained within the conduit 5. This wall thickness may be in the range of 0.01 to 0.5 mm.

The anode, secondary electron production means, vessel wall and external heat transfer fins or the like may be integrated into a cross-sectional form that is suited for manufacture by an extrusion or 3D printing process, in order to manufacture a reduced cost component of the apparatus. Thus, embodiments of the present disclosure may provide apparatus for producing increased nuclear fusion reaction rates with several reactant gas ionization enhancements which are compatible with a low-maintenance and low-cost system.

For embodiments including the embodiment demonstrated in FIG. 2, the conduit enriched anode wall 5 may be manufactured by a fabrication of a stainless-steel back plate and stainless steel or otherwise metallic FIS enriched corrugated front wall. The back plate may be machined or milled which produces typical wall thickness of at least 2 mm. The enriched anode wall 3 may be processed by means of well-known techniques to roll or press the desired corrugation of the desired wall thickness within a tolerance range. Such a process may provide design options by means of selective reinforcing strips to counteract deformation due to the operational pressure difference. The two components may be welded together when the materials are compatible for electron beam, laser or other intensely focused energy welding technique in order to form the anode wall fluid conduit sub-assembly 6. In the embodiment shown in FIG. 2 such sub-assemblies can be slid into position in the vessel wall 1.

In embodiments the fluid conduit structure may be fabricated from a milled steel back plate, which has across section profile that is compatible with the extruded slots on the inside of the substantial vessel wall, and a thin sheet that is pressed or otherwise formed into a wave profile anode wall, the two components being welded together to achieve an ultra-high vacuum compatible seal.

In an embodiment of the present disclosure the fluid conduit anode wall structure may have a relatively thin anode wall with a characteristic thickness that may range between 0.05 mm to 0.5 mm. This thickness may be dictated by the reduction of kinetic energy of the 14.7 MeV protons that is permissible in order that the residual energy range is sufficient for nuclear interactions with certain isotopes that shall be concentrated within the fluid and it may also apply to the length of traverse path for protons which traverse through the anode wall at other than a 90 degrees angle of incidence. This may include protons generated in the anode wall through lattice confinement fusion which may exhibit emission from the inner surface curvature.

In an embodiment of the present disclosure the thin anode wall of the conduit structure may have a complex chemically etched surface where stiffener features which may or may not also be enriched in FIS are aligned with the cathode grid cells in order to better resist the thermal stresses imposed by the impingement of the star mode beams.

The thin anode wall of the conduit structure may be achieved by well know techniques such as chemical etching and protective masking such that structural stiffener features and relatively thin windows can be defined and produced on the anode wall of the conduit structure if deemed necessary. Whilst chemical etching can be used to achieve thin anode walls, this has an added benefit of aiding the hydrolysis process to encourage anode surface purity and to maximise the fusible isotope species enrichment.

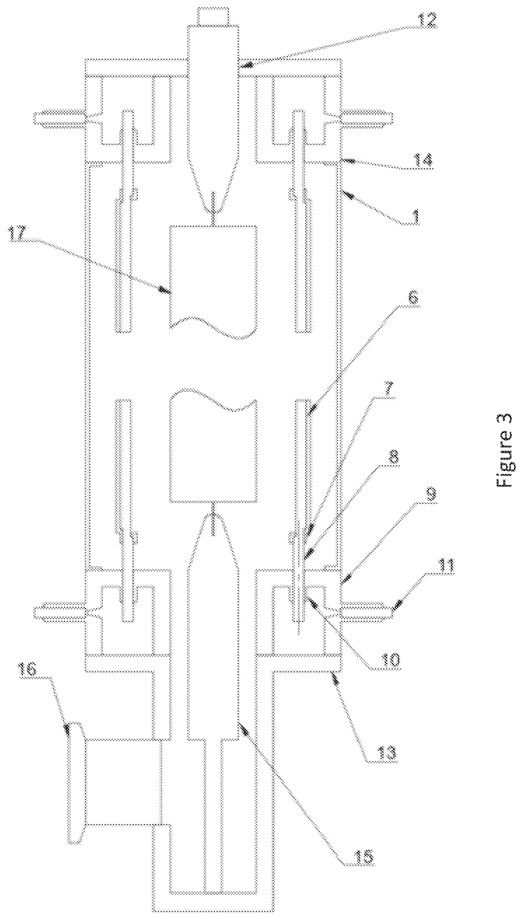

FIG. 3 illustrates a reaction chamber and integrated fluid conduit sub-system assembly of an embodiment of the present disclosure. Specifically, FIG. 3 demonstrates a cross sectional representation of the proton generator IELC for the generation of PET radioisotopes. The following labelled components are: 1 Outer chamber wall, 6 anode support structure, 7 fluid conduit termination block, 8 connecting stub tube, 9 manifold assembly, 10 pipe joint fittings, 11 precursor fluid inlet/outlet, 12 end cap assembly, 13 gas feed end cap assembly, 14 seal gasket, 15 high voltage stand-off component, 16 FIS gas fitting flange and 17 cathode assembly. The length has been diagrammatically cut so that the ends of the reaction chamber may appear on one page. The overall length may be in the range 1-2 metres. The vessel wall 1 may hold 8 enriched anode wall fluid conduit assemblies 6, two of which are shown in cross-section. The central cathode assembly 17 is shown symbolically. The internal features at each end may be milled away to provide better access and accommodation of the fluid conduit assemblies. Each fluid conduit may have a termination assembly which consists of a termination block 7 and a stub tube 8 which may be brazed or otherwise attached so as to achieve a leak free or ultra-high vacuum standard seal. The stub tubes 8 may be inserted into manifold assemblies 9 at each end of the chamber 1. The high vacuum seal connection of each stub tube may be achieved by means of appropriate pipe fittings 10 which are of a welded fitting type that can be welded to the stainless-steel manifold 9.

Inlets and outlets 11 may be similarly implemented by means of welded tube joint fittings 10.

The manifolds 9 may be closed by the end cap assemblies 13. The high voltage feed through end cap assembly 12 may provide a high vacuum seal and the gas feed end cap assembly 13 also may provide a high vacuum seal. The seal gasket 14 may be a “metal O-ring” device. An array of clamping screws may be provided which work against flanges, which are not shown, to clamp the flange faces against the “metal O-ring” seal to achieve a specified deformation and high vacuum seal.

The gas feed end cap assembly 13 may be connected to a gas management sub-system which may be implemented as separate gas pressure regulators for each reactant gas type or as a combination of gas pressure regulator for-Helium-3 and getter pump for Deuterium. The gas feed end cap assembly 13 may enclose a high voltage stand-off component 15 which permits the free movement of gas between the main chamber and the gas port 16.

Embodiments of the present disclosure may incorporate a means of circulating the target fluid through the conduit structure of the fusion fuel loaded anode wall component such that the necessary cooling of the fluid, anode wall and associated reactor vessel structure can be implemented as well as delivering newly formed product isotope bearing compounds to an external location where a chemical means of extraction and concentration can be located within a closed recirculation circuit. Thus, said target fluid may be considered to comprise a proton capture area.

A circular or polygonal reaction chamber may also be so altered as to produce a wide chamber where the fluid conduits 6 are arranged in two parallel planes where any practical width may be determined by the number of fluid conduits 6 to be accommodated side by side, projecting out of the plane of FIG. 3. However, this may result in a reduction in the proton capture area of the fluid conduits 6.

There is also a particle production rate benefit of operating in a pulsed power mode. This is likely due to a combination of lattice confinement fusion, the accompanying electron screening effect and secondary electron emission. The periodic relaxing of the voltage may allow for a higher concentration of valence electrons to briefly return to the surface which increases secondary electron yield and a stronger electron screening effect to increase lattice confinement fusion. Therefore to maximise the gain from operation in pulsed mode, the frequency of pulses must match the relaxation time taken for electrons to repopulate the enriched surfaces after extensive ionisation. Hence, embodiments of the present disclosure may provide apparatus that may utilise pulsed power input whereby the electrical current is in the order of several to tens of amperes during the pulse thereby exploiting an observed fusion rate enhancement characteristic of super linear proportionality with the applied current.

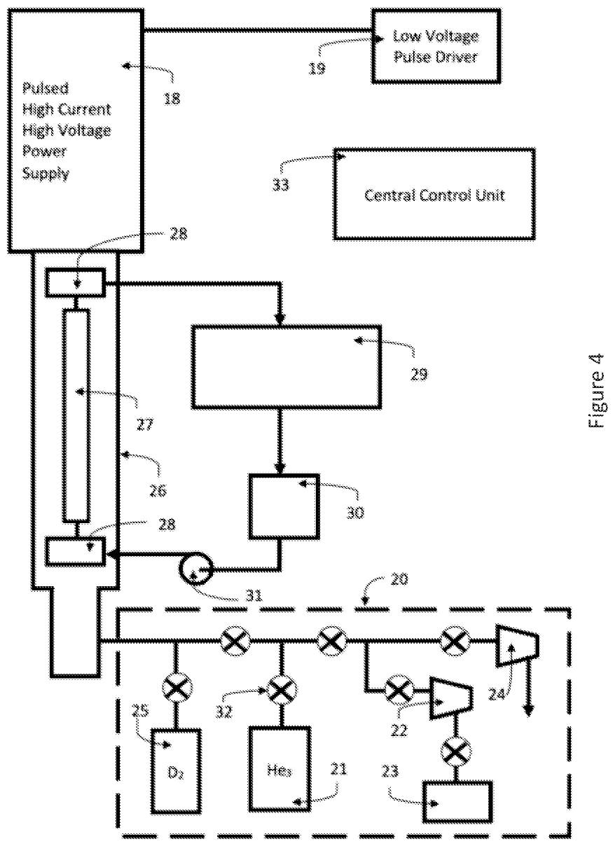

FIG. 4 illustrates a system function schematic. Specifically, FIG. 4 demonstrates a proton generator system function schematic for medical isotope production configuration. The following labelled components are: 18 high voltage power supply, 19 low voltage pulse driver, 20 gas management manifold subsystem, 21 Helium-3 reservoir, 22 turbo molecular vacuum pump, 23 residual reservoir, 24 primary vacuum pump, 25 getter pump, 26 sealed vessel, 27 cathode assembly, 28 manifold assemblies, 29 heat exchanger, 30 isotope extraction system, 31 fluid flow circuit pump, 32 Helium-3 dosage valve and 33 control computer system.

Embodiments of the present disclosure may have the peripheral functions interfaced therewith for effective operation. An important peripheral may be a very high voltage pulsed current power supply which typically consists of a high voltage transformer section 18 and a lower voltage pulse driver section 19. For IEC devices as described in the prior art, the number of particles produced scales linearly with power input. In contrast, embodiments of the present disclosure may produce increased particle production rates beyond that of equivalent IEC systems, such as those of the prior art, while having lower power supply requirements. Thus, the peripheral support equipment needed to support high wattage power supplies is no longer necessary, as large numbers of particles can be produced at smaller power input. Embodiments of the present disclosure may provide apparatus for producing increased nuclear fusion reaction rates with a minimum or reduced amount of peripheral support equipment functions.

The getter pump assembly 25 may be located external to the reaction chamber assembly of FIG. 4 and may be in a manifold assembly show symbolically within boundary line 20. The non-evaporative getter pump may be supported by a power supply, heating element and a temperature measurement circuit (not shown). The power supply may provide voltage and current that is sufficient to power a heater element that may be embedded within the getter pump getter material. The heater may raise the getter material to a temperature in the range of 400° C. to 600° C. The heater may be controlled so that the getter material remains at a steady temperature. The vessel 26 may be sealed and evacuated after it has been correctly baked out to eliminate residual volatile substances such as water. A conditioned getter of the appropriate material may release hydrogen or isotopes thereof so that a partial pressure may rise to the level of 5×10⁻³ mbar to 5×10⁻¹ mbar when it is in the above-mentioned temperature range. At a particular steady temperature, the partial pressure may also be steady. The getter pump at constant temperature may serve as a pressure source and a pressure regulator of high precision. Very minor pressure fluctuations can cause significant departures of the star mode glow discharge voltage. The regulation of pressure can be fine enough with open bleed valve and turbo molecular vacuum pump configurations, but the getter pump may provide a superior means of pressurization of the sealed configuration IELC device.

The capacity of the getter pump 25 to store the reactant gas (Deuterium) may be a factor in determining the maximum number of operation hours of a sealed reactor chamber. A practical configuration may allow ten years of continuous consumption of Deuterium at the rate of up to 1×10¹⁴ fusions per second. During such a period, the output of the sealed reactor can be expected to change very slowly as the mixture ratio of reactants changes. In the D-He3 embodiment, some DD fusion reactions may occur. Tritium and Helium-3 may be generated as well as protons (Hydrogen). The Helium-3 and Tritium may either be accumulated or consumed in the applicable fusion reaction. The contribution of these side reactions may in fact be minimal. The fusion rate in the present embodiment is likely to be 1×10¹⁰ to 1×10¹⁴ per second depending on the fusible species enrichment level. It is feasible to perform maintenance on a sealed chamber by opening the fill and vent port (not shown), extracting the gas by heating the getter pump and baking the chamber to induce outgassing of the embedded volatile species in the inner wall surfaces 3 and 1 of FIG. 2, 3. The handling of Tritium may be subject to safety regulations. However, the amounts of Tritium that may accumulate in a well-used D-He3 reactor embodying the present disclosure are expected to be below the lowest safety threshold for handling and transport in most countries. The gas management manifold subsystem 20 may also include a reservoir of Helium-3 in a pressure vessel 21. When a servicing operation is to be implemented, the reaction chamber is evacuated to the minimum practical pressure level. The high cost of Helium-3 may require a scavenging system where a turbo molecular vacuum pump 22 directs residual Helium-3 which may be at an initial partial pressure of 1-5×10⁻² mbar into a reservoir 23 for re-use.

Embodiments configured for the utilization of Helium-3 may have an external means of storing and regulating Helium-3, and eventually handling and separating Helium-4, in addition to a getter pump for the Deuterium gas.

The entire gas manifold sub-system may include a primary vacuum pump 24 for initial evacuation and support of subsequent operation procedures. Numerous dosage valves and shut-off valves (shown generically) may be included to support an automated configuration control implementation.

The enriched anode and vessel walls may comprise a combined functional element and may incorporate external fins or other heat transfer structures or surfaces for heat transfer by means of flow of a heat transfer fluid, generally a cooling fluid, over the fins or other structures or surfaces.

More specifically, an embodiment for isotope production may have a chamber assembly 26 within which the vessel wall or anode wall may be lined with fluid conduit assemblies 27, of which there are 8 in the an embodiment. These may be connected to manifold assemblies 28 at each end so as to ensure that the contained aqueous fluid is hermetically sealed from the vacuum-like environment of the reaction chamber. The manifold assemblies may be equipped with ports to enable a fluid flow circuit to be configured. The fluid flow circuit may include the main functional features of a heat exchanger 29 to remove a substantial fraction of the heat delivered to the chamber by the high voltage power supply. Further functional features in the fluid circuit may be the means to extract the P.E.T. Isotope 30 and a particulate filtration system. The fluid flow circuit may be completed by a pump 31. All components may have to be of medical equipment standard.

For the purposes of the present embodiment, there may be software which controls the glow discharge voltage, pulse current and pulse duty cycle that the high voltage power supply 18, 19 may deliver. The voltage may be determined by the gas pressure in the chamber 26. The gas pressure may be determined by the getter pump temperature which may be measured and sent to the software by a temperature measurement circuit. Getter pump temperature may determine Deuterium partial pressure. The software may command the getter pump heater power supply to deliver more or less power in order to maintain the getter pump temperature. The software may also command a dosage servo valve control unit to maintain a pressure. This software function may control the partial pressure of Deuterium determined by the Getter Pump 25 and the Helium-3 dosage valve 32 so that the mixture ratio of the two gaseous elements may be equal in terms of number of atoms. Command or control signals may be issued to the necessary sub-systems so that the reactor operates at or very near to the parameters required for the optimum production of isotopes. The control algorithm is not trivial due to several non-linear characteristics; however, the response time may be sufficiently long that a typical computer or dedicated micro-processor control computer 33 with the necessary input and output ports can easily cope with cyclical monitoring and control tasks. The net result may be that steady proton production rates are achieved.

A further feature of the present disclosure is the capability to automate all processes and ensure high reliability, redundancy and safety standards. The ancillary equipment illustrated in FIG. 4 may be monitored and controlled by the Central Control Unit 33 computer system. Such a system may have a user interface so that qualified operators can oversee and give high level commands to the PET isotope producer system, for example. The Central Control Unit 33 may ultimately be driven automatically by a software program that oversees the safety interlocks, start-up and shut-down sequence, normal steady state operating parameters and management of minor and major anomalies. The operator can also input certain control parameters and command the proton generator system to start the warm-up mode, start the proton generation mode, stop or go to stand-by from the proton generation mode, resume the proton generation mode, and finally initiate total shut-down of the system. The control of the fluid circulation sub-system may also be controllable but advantageously it may be automated in order to support the reaction chamber cooling function. There may be a sub-set of functions associated with the isotope filter 30 operation.

A unique capability of the IELC is low-cost scalability. Usually, with the usage of two-point sources, there is a doubling of the cost of the neutron source. This is tolerated for some commercial neutron analysis systems where Cf-252 has been the only practical source. However, it is more problematic for a neutron application system that would use two neutron generator devices. Since each individual neutron generator system consists of the reactor device, a high voltage power subsystem, an electronic controller sub-system and ancillary cooling sub-system, multiple copies of the equipment would be required. The operation of two or more sealed tube devices connected in parallel to one set of appropriately specified ancillary sub-systems seems to be only a marginal cost reduction compared to two separate sealed tube neutron generator sets. IELC systems can be connected in parallel electrically as well as connected physically in series through a continuous tube. This allows for significant cost savings in the more expensive parts of the system, the power supply and the ceramic insulators. This implies cost reduction when scaling up such systems as opposed to alternative accelerator-based generators. Additionally, such geometric configurations provide more homogenous neutron fluence over a large sample area for fusion materials testing or isotope generation in large volume vessels where a similar fluence would be prohibitively expensive to replicate with accelerator-based systems.

Preferably, the apparatus may be adapted to generate neutrons in a “macro” linear or curvilinear geometry, where the expression “macro” is used to distinguish between a relatively small “micro” sized neutron source geometry such as a single pellet of radioactive isotope and a “mega” sized neutron source such as a fission reactor core or a star. In other words, “macro” implies a size or scale that is useful for industrial applications. This may range from approximately 1 cm line source length for envisaged medical neutron beam source applications to several metres for a land mine search, soil analysis or other similar applications. The macro characteristic also implies that the macro scale device may be built from an ordered collection of micro sized units. Allowing for higher flux density by alignment in parallel or perpendicular where controlled enrichment of the anode wall allows for the weighting of the particle production rate to specific areas of the macro system. This is the case in certain embodiments of the present disclosure which efficiently stack micro star beam cells into a linear arrangement which may consist of two or more cells, typically several tens of cells.

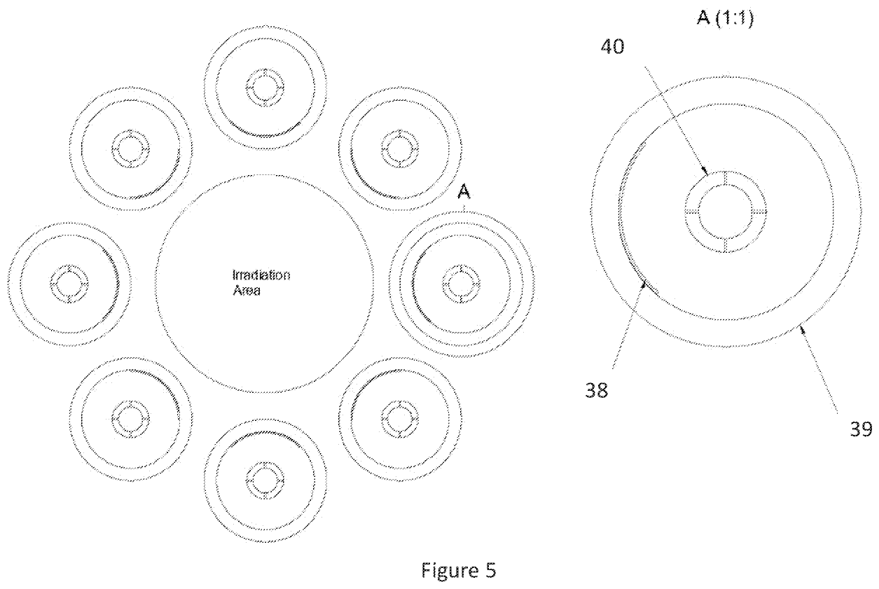

FIG. 5 represents a parallel configuration of systems 35 which present an embodiment for compact, high volume radioisotope production or material irradiation whereby the inner anode surfaces 34 which face the irradiation area are FIS enriched in a localised fashion, encouraging LCF and particle production in proximity to the high flux irradiation area. The following labelled components are: 34 localised fusible isotope species enriched inner anode surface, 35 outer vessel wall and 36 cathode assembly. This geometric configuration may allow for a more homogenous flux over a wider volumetric area, making it ideal for fusion materials testing for critical subsystems such as breeder blankets, superconducting magnets and heat extraction systems. Thus, embodiments of the present disclosure may provide apparatus for producing nuclear fusion reaction rates of high rate and reproducibility in mass produced embodiments.

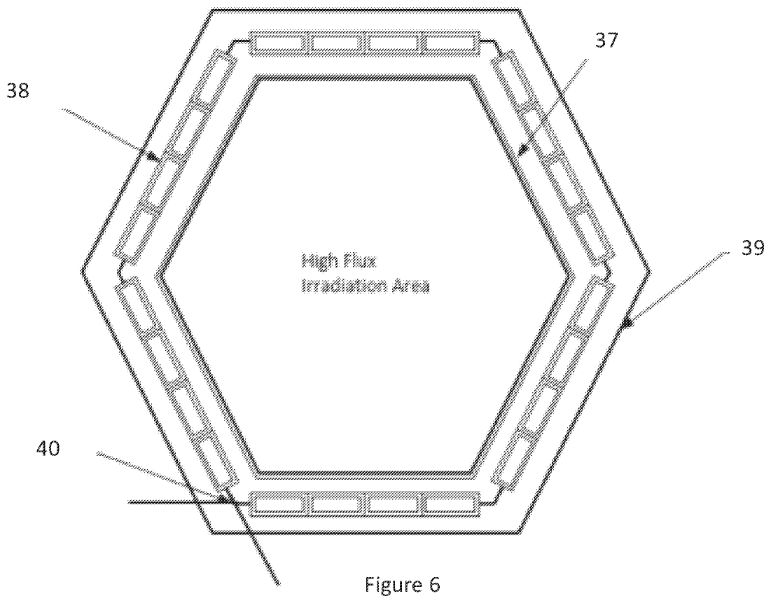

Advantageously, the cathode structure or cathode assembly 36 may have open faces on its circumference and is encircled by an anode and vessel wall structure. The cathode structure may comprise a plurality of cathodes stacked prism-end to prism-end with generally identical electrode structures to establish an elongated array that in star mode operation may establish a stable plasma gas dynamic structure within whose star mode beams of generally radially oscillating ions there may occur a high probability of nuclear fusion reactions whose escaping neutrons may appear to an external observer with suitable neutron detecting instrumentation to originate from a zone defined by an internal volume space of the anode electrode and the inner surface or wall of the vessel. The prism-end of an electrode refers to the flat surfaces at the ends of the electrode when the electrode is formed in a prismatic shape, for example a cylinder. In the present disclosure the protons may behave similarly but do not escape from the reactor vessel. Thus, embodiments of the present disclosure may provide apparatus for containing nuclear fusion reactions to produce protons and other reaction products which are contained within the reactor vessel wall and a relatively small flux of neutrons that can escape from a sealed apparatus in all directions from a zone of origin that is elongated. FIG. 6 represents the series configuration of systems which present an embodiment for scanning large moving objects such as those in luggage or within transport containers moving along a conveyor belt or train at speed. In other words, FIG. 6 demonstrates a multiple unit configuration arranged in series, including localised anode enrichment. The following labelled components are: 37 localised fusible isotope species enriched inner anode surface, 38 outer vessel wall, 39 cathode assembly, 40 central high flux irradiation area. The preferentially FIS enriched inner anode wall surfaces 39 may allow for a concentrated and homogenous flux across a hexagonal axis plane. The cathode structures 38 connected in series may include overlapping high voltage feedthroughs with separate ceramic insulators 40 so as to avoid a short circuit arcing.

Multiple cathode structures 38 connected in series may be referred to individually as cathode cage cells. Thus, embodiments of the present disclosure may provide apparatus for producing nuclear fusion reactions in a zone whose length can be specified as multiples of a single cathode cage cell length.

Examples of possible embodiment characteristic dimensions:
I. Inside diameter of the anode and vessel wall 8 cm
II. Diameter of the cathode grid electrode 3 cm
III. Length of the cathode grid electrode 80 cm
IV. Length of the proton line source 80 cm
V. Overall length of the reactor chamber
VI. and power supply assembly 180 cm

Embodiments of the present disclosure functioning as a generator are well-suited for arranging Beryllium, Nickel or Lead to be formed into the slot-in anode wall structures whereby the generated neutrons or protons may have nuclear interaction with these elements or others similarly incorporated into the reactor chamber wall so as to generate further nuclear particles.

Embodiments of the present disclosure functioning as a proton generator are well-suited for production of radioactive isotopes that are used in Positron Emission Tomography. This is because the Deuterium and Helium-3 fusion reaction releases a proton with an energy of 14.7 MeV. Proton energies in the range of 8 to 18 MeV have been found to be necessary for reaction with Oxygen-18 to produce Flourine-18 which is a P.E.T. Isotope. The passage of a proton through a membrane or foil made of metal causes a reduction of the kinetic energy of the proton. For example, a proton of a given energy may penetrate approximately 1.5 times deeper in Aluminium than in Steel. Practically with 14.7 MeV protons the anode wall thickness may need to be less than approximately 0.3 mm in order to have an exit proton energy of 8 MeV. An even thinner anode wall thickness may raise the residual proton energy available for the intended interaction with the target isotope nuclei. If an engineering assessment leads to the choice of stainless steel due to its more favourable properties for fabrication, the typical wall thickness may be in the range of 0.05-0.5 mm with a preferred value of 0.1 mm.

P.E.T. scanning facilities have had to be located in very close proximity to devices such as proton accelerators which produce energetic protons. The present improvement may provide an energetic proton source and target irradiation device which has the potential to have significantly lower manufacturing and operating cost with a performance that can support patient P.E.T. scanning protocols. The essential sub-systems may include the fusion reactor vessel, a compact high voltage pulsed power supply, a system for reactant gas pressure regulation and storage, a system for target fluid circulation and/or cooling, a system for isotope recovery, separation and refinement.

The precursor fusion-fuel gas may generally consist of fusible isotopes at a low pressure suitable for glow discharge to be induced. The low partial pressure (5×10⁻³ mbar to 5×10⁻¹ mbar) may be compatible with a chemical non-evaporative getter pump that may have the characteristic of producing a constant partial pressure of hydrogen isotope for a constant temperature of the getter material. The getter pump may serve as a gas storage and pressure regulator in a hermetically closed chamber and may be useful in a practical industrial embodiment of the disclosure. The getter temperature may be controlled by automated means to maintain a target voltage across the electrodes as determined by a gas-plasma pressure. The partial pressure of Helium-3 may be controlled by a closed loop controller of a micro dosage valve in combination with the Deuterium getter pump. Depending on the rate of fuel consumption and product gas production, occasional purge cycles may be devised. The high voltage power supply preferably has pulsed current capability that may be employed to establish near-constant electrical average power input to the IELC device. This may yield a corresponding stable fusion rate and isotope production rate. Pulsed operation with pulse duration of 5 to 100 micro-seconds is considered optimal for mitigation of local hot spots on the cathode that may act as sources for arcs and consequential severe local heating. The longevity of the reactor chamber assembly may be limited by the deposition of metal onto the internal insulator surfaces. Avoiding this relies upon the utilization of micro-channel beam distribution to mitigate metal vapour migration to the ceramic feedthroughs and stand-off insulator surfaces. The dimensions of the cathode may be such that radiant heat is effectively transferred to the anode chamber wall and then further transferred to an external cooling system via the circulating fluid in the conduit. This may ensure that the operating temperature of the cathode grid remains sufficiently low to effectively mitigate significant metal vapour pressure and the decomposition of Deuterium and/or Tritium containing Hydrides. Through use of CVD diamond coatings for the cathode and anode, thermal stresses and metal evaporation may be minimised whilst encouraging secondary electron emission as well as implying that sputtering of the surfaces by the plasma may release Carbon ions, which are less detrimental to the energy of the plasma compared to heavier metallic ions which soak up free electrons.

Due to the absence of charge for a neutron, the present disclosure lends itself to fast-neutron imaging and diagnostic techniques where probed materials experience little to no measurable damage after investigation as the vast majority of particles pass through and the measured perturbances are from kinetic clastic interactions which tend to leave the material relatively undamaged. These elastic interactions differ between isotopes of the same element, making the technique uniquely useful for investigating the atomic composition of suspicious packages, valuable archaeological artefacts or unidentified technology. The same is true for biological targets when the total dose is kept below an adequate level.

Whilst passing through a material, neutrons can cause nuclear reactions with target nuclides either through threshold reactions, where at an adequate energy the nucleus is split into residual nuclides, or thermal neutron capture events which transmute nuclides into different isotopes or elements releasing secondary particles such as gamma rays. The secondary gamma emission spectra from neutron capture reactions are well documented and underpin applications such as neutron activation analysis, thermal neutron analysis and prompt gamma neutron activation analysis. Even for particle generators with a low neutron production rate (NPR) of 1×10⁹ ns⁻¹, isotopes with a large neutron capture cross section, such as Nitrogen-14 or Uranium-235, can easily be detected given sufficient irradiation time and gamma detection equipment. At higher NPR and with sensitive gamma detection equipment materials can be probed extensively and their atomic composition assessed to high precision. Previously to the current disclosure this has only been possible through use of a fission reactor or costly accelerators.

In some applications, the neutron flux must be precisely defined in order to be generally accepted as part of an approved medical therapy. The quality of the neutron flux from accelerator sources or sealed tube neutron generators is deemed to not to be ideal. Accelerator spallation neutron sources may generate a range of neutron energies, making them more challenging to moderate and thermalise than for mono-energetic sources. Sealed tube devices do provide mono energy neutrons but suffer from poor reliability of the neutron output as do the accelerator spallation neutron sources. The solid targets that these devices use suffer from altered characteristics due to the damage they incur through use. The combined electrostatic-lattice confinement fusion of fusible ions from a neutral gas and ion mix plasma does not suffer from target degradation as damage is distributed across the anode and cathode surfaces, where diffusive and infusive processes reach an equilibrium during operation. Additionally, the FIS are continuously renewed in the plasma in a stable state. Reactant gas contamination can be mitigated so that the neutron output quality can be constant for a given set of controllable operating parameters.

The combined Inertial Electrostatic-Lattice Confinement (IELC) fusion device represents a very versatile particle generator, where the chosen isotopic fusible species produces mono-energetic particle spectra of energies seen through equations 1-4. These modes can then be adjusted further by altering operating conditions such as the power input of voltage and current in direct or pulsed configurations as well as the operating temperature of the anode, meaning that the total particle production rate of each setup can be tailored to a specific application for which the generator is built for. Examples of different applications of the IELC include as a proton generator to produce PET medical radioisotopes, as a neutron generator for diagnostics and imaging or neutron activation applications as well as pulsed mode neutrons for detection of explosives and fissile material.

In tandem with the capability of continuous neutron output, an advantage that any electrical neutron generator should offer is the ability to switch on and off repeatedly to create a pulsed mode of operation. The pulse mode duty cycle may range from minutes or seconds of ON time and similar intervals of OFF time to milli-, micro- and even nano-seconds. It may not be necessary, cost effective or practical to offer the entire pulsing duty cycle range in every neutron generator. The main advantage of the pulsing mode is to cut off the noise caused by the higher energy neutron interactions and then detect the thermal neutron or other delayed interactions where prompt gamma photons are not emitted instantaneously. The implementation of mechanical shutters to make Cf-252 or fission-based beam hole sources into a pseudo-pulsed neutron source is not practical or cost effective. Additionally, from a safety perspective the concept of a particle generator with a built-in kill switch is very attractive.

A non-point source geometry may be advantageous for the design of neutron collimation systems. Such peripheral systems may include neutron moderation to reduce the mean energy of the collimated flux of neutrons. The object of neutron collimation is to establish a beam of neutrons with specified flux density and neutron energy characteristics. Since neutrons are not charged particles, they do not respond to electrostatic or magnetic fields. Collimation devices rely on the interaction of neutrons with certain materials to obtain reflections and refraction-like changes of velocity. It may be envisaged that embodiments of the present disclosure may offer new conceptual configurations of neutron source and collimation systems for specific applications. Beryllium, Lead and Nickel can act as such multipliers, moderators and reflectors for neutron collimation. The fluence of neutrons can be coerced to a certain extent, masked and directed to create specific flux patters for different purposes. In the fusion industry this is particularly useful for component irradiation testing where the expected fluence at that point in the reactor can be replicated by a combination of masking, moderation and collimation.

The sealed tube neutron generator technology is inherently age-limited by the unavoidable erosion of the solid target. This component is a metal such as titanium that has been impregnated with tritium or deuterium gas. The incident high energy deuterons have the effect of causing sputter erosion of the target. The sputter product condenses as a metallic film on the inside surfaces of the sealed tube device. The use of voltages near 100 kilovolts results in a short circuit condition as the metallic film builds up. Even before this ultimate failure mode, the highly localized beam causes a hot spot and associated gas depletion within the target. Various neutron yield degradation mitigation schemes have been employed but the fact remains that the best guaranteed lifetime of a scaled tube neutron generator is only 4000 hours. The present disclosure spreads the thermal and radiation damage during operation over a wider surface area of the anode and cathode resulting in an inherent advantage in durability compared to accelerator-based competitors.

A common issue regarding the longevity of both spherical and cylindrical IELC devices based on observations of experimental units where stainless-steel wire electrodes would suffer structural failure after perhaps 10-20 hours of operation at voltages ranging from 20 to 60 kilovolts and applied current of approximately 5 to 30 milliamperes. The mode of failure was metal vaporization or erosion and deposition on the surface of insulator components which would inevitably lead to short circuit conditions. The lifetime of systems in accordance with the present disclosure may exceed the claimed lifetime of commercial sealed tube beam-solid target neutron generators by 50% and are expected to be able to be run indefinitely. A mean time between failures of 20,000 hours or more may be expected for some embodiments of the present disclosure.

For commercial success, embodiments of the present disclosure are simple enough to enable manufacturing, operation and maintenance costs to be less than the life cycle costs associated with competing accelerator-based particle generators as a result of a reduction of the piece part count in the assembly, low piece part manufacturing costs, quick assembly and inexpensive quality assurance checks. Individual components or subassemblies have high durability in their intended function within embodiments of the present disclosure. The combination of sub-systems and their functions preferably reduce operational control of the variable parameters so that the increased degree of automation enables operation of the system by personnel with less training.

The present disclosure is capable of being configured as the core of a compact system for the production of certain isotopes that are used by the medical or non-biological tomographic scanning processes such as Positron Emission Tomography (P.E.T.) Scanning. This Positron Emission Tomography utilizes the pair of 511 keV gamma photons arising from positron (positive charge electrons or antimatter electrons) decay of certain radioactive or unstable isotopes where the annihilation of the positron and an electron converts the rest mass (i.e. 2MeC²) generally to two gamma ray photons that are emitted with exactly opposite velocity vectors. The gamma detecting sensors are typically arranged in a ring through which the patient or object to be scanned is passed. Given sufficient quantity and time the detected 511 keV emissions can be mapped to build up a tomographic or three-dimensional data field that may be presented as visual slices or three-dimensional models of the scanned object or patient's internal body structure. Other processes a technique make use of x-ray or beta particle emitters of similar energy for the same purpose however producing a lower fidelity image or to deliver radiotherapy to specific regions of the body. More recently, elements such as Zirconium which happen to have both a beta and x-ray emitting isotope can be used to diagnose areas of the body with cancers as well as deliver a radiotherapeutic dose in an effective an accurate treatment known as theragnostics.

The choice of isotope that may be used for P.E.T. Scans is determined by the biomedical considerations which are too complex for a useful discussion here. The commonly listed P.E.T. Isotopes, their half lives and their generation reactions are:

| | |
|---|---|
| 5. N₇¹⁴ + p₁¹ → C₆¹¹ + α | 20.4 minutes half-life |
| 6. O₈¹⁸ + p₁¹ → F₉¹⁸ + n₀¹ | 109.8 minutes half-life |
| 7. O₈¹⁶ + p₁¹ → N₇¹³ + α | 10.0 minutes half-life |

Historically such medical radioisotopes are produced in commercial reactors or accelerators in a centralised setting where the longer half-life of conventional isotopes, such as Mo-99, allow for chemical processing and delivery to hospitals within three half-lives. This has meant that imaging techniques are limited to low specific activity radioisotopes that have travelled several days to reach the hospital. Whereas newer isotopes, such as Carbon-11 and Nitrogen-13 that have much higher specific activity and are more readily incorporated into molecules that are accepted by the body or targeted organs, can only be used by facilities within a close proximity to a reactor or accelerator. This has stymied the adoption and use of well-established advanced techniques and treatments limiting them to regions of the world which can afford large accelerators or fission reactors. Due to the endemic challenges of the supply chain, patients that would benefit from these treatments may not be offered them. The present disclosure allows for the production of isotopes within the hospitals that use them and at a fraction of the cost of building alternative particle generation capability.

The conventional way of producing these isotopes is to have the source isotope enriched in a target medium such as a water-based solution. The target solution is bombarded by a stream of energetic protons with an energy sufficient to allow penetration of a barrier wall and still have enough residual energy for the required nucleus interaction leading to the formation of the desired isotope. The wall thickness is typically that of a metallic foil (0.1 to 5 mm).

The source of protons is usually a particle accelerator of a cyclotron or linear accelerator type, where the imparted proton energy is usually greater than 5 MeV. Some linear accelerators are offered with 12 MeV of proton energy. The proton beam intensity is several milliampere of current with a focal point characteristic dimension of several millimetres diameter. This constitutes an intensified spot of radiation and heat generation. An engineering issue faced by designers of this type of PET isotope production system is the extremely localised and intense thermal energy produced in the target medium. This can include superheating of the water which requires pressurization to keep the water in liquid form for most efficient proton-nucleus collisions. The present disclosure provides a system with markedly lower running costs as the ions only require acceleration to few 100 keV of energy in order to produce fusion particles on the order of 14 MeV. Additionally, the thermal stresses on the devices as well as the vessels containing the precursor isotopes in spread over a larger area implying less complexity and need to replace parts regularly. For accelerator-based particle generators it is challenging to spread the proton beam over a wide area whether through direct acceleration or from a spallation fusion reaction. Due to this, such systems have higher maintenance costs and struggle to run continuously as irradiated materials need regular replacement due to sputter erosion and proton damage.

The present disclosure therefore offers an intrinsically lower manufacturing cost with a longer interval between servicing of the combined particle generator and target subsystem. The thermal flux imposed per unit area or unit volume of the target is much lower because a proton beam is not utilized, and the proton flux is evenly distributed over the entire internal surface area of the reactor chamber wall. This further reduces the complexity and cost associated with the cooling subsystem.

The present disclosure has the capability of serving the radioisotope needs for a cluster of hospitals within a catchment area. Many hospital hubs exist in city centres around the world where each sits a short distance from the other for logistical purposes. A system in Deuterium-Deuterium or Deuterium-Tritium neutron mode could be set up in the basement of one hospital in a shielded area to produce for example, Mo-99 and Lu-177 for the other hospitals in the catchment area. Alternatively, a Deuterium-Helium-3 mode proton generating system could be paired with a mobile PET scanner from a secure vehicle. Such systems are well-suited to generate multiple isotopes simultaneously where separate channels contain Oxygen-18 or Oxygen-16 water to generate Flourine-18 or Nitrogen-13 respectively for example. Each isotope can be chemically extracted from the circulating fluid on-demand.

While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A particle producing apparatus of the inertial electrostatic confinement type, comprising:
a vessel;
an anode structure;
a cathode structure, wherein the anode structure and cathode structure are positioned within the vessel; and
a first enriched surface, the first enriched surface being enriched with fusible isotope species wherein the first enriched surface is at least a part of a surface of the anode structure or a surface of the cathode structure.

2. A particle producing apparatus as claimed in claim 1, wherein the apparatus is configured to contain an ion and neutral gas mixture and, in operation, to cause the ion and neutral gas mixture to form a plasma.

3. The particle producing apparatus of claim 1, wherein the vessel comprises a central axis, the anode and cathode structures are positioned such that the anode structure and cathode structure are substantially coaxial with the vessel, the anode structure having a mean distance from the central axis that is larger than the mean radius from the central axis of the cathode structure, the anode and cathode structures are substantially concentric along at least a part of their lengths and configured such that, in operation, an electric field is provided between the anode and cathode structures and the first enriched surface is electron screened.

4. The particle producing apparatus of claim 1, wherein the vessel has a substantially constant cross-section coaxially along the length of the cathode structure.

5. The particle producing apparatus of claim 1, wherein the anode structure is formed of a plurality of anode units.

6. The particle producing apparatus of claim 1, wherein the first enriched surface is formed of basic or transition metals.

7. A particle producing apparatus as claimed in claim 6, wherein the metal is an element with an atomic number greater than or equal to 40.

8. A particle producing apparatus as claimed in claim 7, wherein the element is one of Titanium, Zirconium, Palladium, or Erbium.

9. The particle producing apparatus of claim 1, wherein the first enriched surface is formed of a semiconductor material.

10. A particle producing apparatus as claimed in claim 9, wherein the semiconductor material is CVD diamond.

11. The particle producing apparatus of claim 1, wherein the first enriched surface is provided as a coating on the anode structure or cathode structure.

12. The A particle producing apparatus of claim 1, wherein the first enriched surface is formed integrally with the electrode that it forms at least part of the surface of.

13. The particle producing apparatus of claim 1, wherein the apparatus is configured such that, in operation, the apparatus produces nucleons.

14. A particle producing apparatus as claimed in claim 13, wherein the nucleons are neutrons.

15. A particle producing apparatus as claimed in claim 13, wherein the nucleons are protons.

16. A particle producing apparatus as claimed in claim 15, wherein the apparatus further comprises fluid conducting structures proximate to the anode structure.

17. A particle producing apparatus as claimed in claim 16, wherein the fluid conducting structures are composed of a metal alloy.

18. The particle producing apparatus of claim 16, wherein the fluid conducting structures comprise corrugations along a length of the fluid conducting structures.

19. The particle producing apparatus of claim 1, wherein the first enriched surface covers a portion of the surface area of the anode structure or cathode structure such that in operation the produced particles have a localised flux with a predetermined geometry.

20. The particle producing apparatus of claim 1, wherein the first enriched surface is at least a part of the surface of the anode structure, and a second enriched surface is at least a part of the surface of the cathode structure, the second enriched surface being enriched with fusible isotope species.

21. A system comprising a plurality of particle producing apparatuses, wherein at least one particle producing apparatus is a particle producing apparatus as claimed in claim 1, the system being configured such that a single power supply can serve several particle producing apparatuses.

22. The particle producing apparatus of claim 1, wherein the apparatus forms part of a Positron Emission Tomography (PET) scanner.
